(19) United States
(12) Patent Application Publication
(10) Pub. No.: US 2021/0259292 A1
(43) Pub. Date: Aug. 26, 2021

(54) GEL-TYPE FOOD COMPOSITION AND MANUFACTURING METHOD THEREFOR

(71) Applicant: SAMYANG CORPORATION, Seoul (KR)

(72) Inventors: Bo Ram CHO, Seongnam-si (KR); Jin Soo NOH, Seoul (KR); Kwang Soo KIM, Seongnam-si (KR); Su Youn LIM, Seoul (KR)

(21) Appl. No.: 17/255,645

(22) PCT Filed: Jun. 28, 2019
(86) PCT No.: PCT/KR2019/007914

§ 371 Date: Dec. 23, 2020

(30) Foreign Application Priority Data
Jun. 29, 2018 (KR) 10-2018-0076076
Jun. 28, 2019 (KR) 10-2019-0077666

(51) Int. Cl. A23L 21/15; A23L 33/145; A23L 33/105; A23L 29/269; A23L 29/238; A23L 29/256; A23L 29/30

(52) U.S. Cl. CPC A23L 21/15; A23L 33/145; A23L 33/105; A23L 29/27; A23V 2002/00; A23L 29/256; A23L 29/37; A23L 29/35; A23L 29/238

(57) ABSTRACT

The present invention relates to a gel type food composition with excellent storage stability and a method for preparing thereof, and more specifically, relates to a gel type food composition having excellent physical properties by reducing changes of physical properties, contamination and syneresis during storage or distribution.

### BACKGROUND OF THE INVENTION

### (a) Field of the Invention

The present invention relates to a gel type food composition with excellent storage stability and a method for preparing thereof, and more specifically, relates to a gel type food composition having excellent physical properties by reducing changes of physical properties, contamination and syneresis during storage or distribution.

### (b) Description of the Related Art

Gel-like or gel type foods are coagulative foods prepared by cooling and solidifying a sol-like solution made by mixing a gelling agent such as agar, gelatin, carrageenan, locust bean gum, and the like, and saccharides, acidulants, fruit juices and so on, and have been ingested since ancient times, and also currently, have been widely ingested as snacks and desserts in the United States, Europe and Japan in addition to the domestic.

In particular, as the diet is diversified and advanced, consumption of jelly foods has increased, and stick type jelly tends to be consumed a lot for increasing the ease and portability of intake methods. In addition, due to increasing of health-conscious consumers such as well-being, natural ingredients such as fruits and vegetables are added to jelly foods to emphasize freshness and functionality.

When high acidic fruit juices, fruit juice extracts, organic acids and the like are used to improve the taste of jelly foods, the pH of jelly foods is lowered. While reduction of the pH of gel type foods has an advantage of ensuring the safety against microorganisms during the distribution period after preparation, it also has a disadvantage of difficulty in forming and maintaining gel, and this is because the most important gelling agent (gums) which forms physical properties of jelly foods shows a big difference in the degree of gel formation and maintenance of gel strength depending on the pH condition. In particular, in case of stick type jelly (jelly stick), it is difficult to implement a jelly food which is soft and has less syneresis and has excellent touch in the mouth while maintaining a stick-specific form at an acidic pH.

However, when a gum composition containing carrageenan is used in the preparation of jelly foods under the acidic pH condition, it is difficult to form jelly, such as the gel is easily collapsed and syneresis occurs. Carrageenan requires inorganic salts such as calcium and potassium and the like in gel formation (for example, Korean Patent Publication No. 2000-0065637).

Conventional stick gel type foods tend to reduce intake convenience and lower consumer sensory preferences, as the hardness and springiness are weekend and the syneresis is deepened over time. Accordingly, it is preferable to improve physical properties in order to minimize changes of physical properties and syneresis even during distribution by maintaining the hardness at a certain level or more in the initial production.

### DETAILED DESCRIPTION OF THE INVENTION

### Technical Problem

An embodiment of the present invention relates to a gel type food composition having excellent properties by reducing changes of physical properties, contamination and syneresis during storage or distribution.

Another embodiment of the present invention relates to a gel type food composition with excellent masking effect for the off-taste and/or off-flavor, when it includes yeast extracts.

A further embodiment of the present invention has a specific range of hardness and springiness capable of maintaining a stick form without falling down even when squeezed into a stick container, or being taken while maintaining a stick form. The present invention relates to a gel type food having a specific range of hardness and springiness and a method for preparing thereof, because a stick gel type food is capable of being taken while maintaining a stick form.

### Technical Solution

The present invention relates to a gel type food composition with improved properties, for example, a stick gel composition and a method for preparing thereof, and more specifically, relates to a stick gel composition comprising allulose.

The present invention relates to a stick gel type food composition comprising a gelling agent and saccharides, in which the saccharides comprise allulose and the stick gel type food composition has the springiness of 0.6 to 0.9 and the hardness of 400 to 2,000 g, as measured by a texture analyzer.

Another embodiment of the present invention relates to a stick gel type food composition including a gelling agent, saccharides and extracts, in which the saccharides comprise allulose and the extracts are one or more kinds of extracts selected from the group consisting of fruit, plants and microorganisms.

The saccharides may further comprise at least one selected from the group consisting of glucose, fructose and sucrose, and the composition may further comprise at least one selected from the group consisting of sugar-alcohols, dextrin and oligosaccharides.

The stick gel type food composition may further comprise one or more kinds of extracts selected from the group consisting of fruit, plants and microorganisms, and the extracts may be one or more kinds of extracts selected from the group consisting of yeast extracts, turmeric extracts, seaweed extracts, green tea extracts, pomegranate extracts, mango extracts, apple extracts, orange extracts and lemon extracts.

An additional embodiment of the present invention provides a stick gel type food composition including yeast extracts, fruit extracts and a gelling agent, and is to provide a gel type food composition with excellent masking of off-taste and/or off-flavor of the yeast extracts. The fruit of fruit extracts may be at least one selected from the group consisting of mangoes, bananas, raspberries, strawberries, pineapples, peaches, oranges, lemons, citrons and apples, and it may further comprise at least one selected from the group consisting of turmeric extracts, seaweed extracts and green tea extracts. The extracts may be extracted with a solvent, for example, water, and include all of fruit juices of extracting fruit juice of fruit, concentrates of fruit juices, filtrates of concentrates, and the like, but not particularly limited.

In an embodiment of the present invention, when the fruit extracts are mango extracts, concentrates 2 (cloudy type) of mango fruit juices or concentrates 1 (clear type) of removing fibers of the concentrates may be used respectively or in mixture. When the mixture of the concentrates 2 (cloudy type) of mango fruit juices and concentrates 1 (clear type) of mango fruit juices is used, it may be 4:1 to 1:4 weight ratios, for example, 3:1 to 1:3 weight ratios, 2.5:1 to 1:2.5 weight ratios, 1.5:1 to 1:1.5 weight ratios, or 1:1: to 1:1.5 weight ratios.

Hereinafter, the present invention will be described in more detail.

The present invention relates to a gel type food composition with excellent storage stability and a method for preparing thereof, and more specifically, relates to a gel type food composition including allulose with excellent physical properties by reducing changes of physical properties, contamination and syneresis during storage or distribution.

Herein, a stick gel type food refers to a coagulative food prepared by solidifying a sol phase solution including a gelling agent with cooling, and it maintains a certain shape and has elasticity. Herein, a stick gel type food is preferably a semi-solid (form not falling down) soft gel, and has a specific range of hardness and springiness ingestible while maintaining a stick form. Herein, as a stick gel type food can have a specific range of hardness and springiness which are required for being ingestible with maintaining a stick form as above,

The stick gel type food according to the present invention has differences in physical properties or shapes and/or package types of completed products, compared to jelly foods of confectionary contained in plastic cups or plastic bags only with a gelling agent such as gelatin or agar, or the like. Gummy jelly having a specific shape (bear, fruit shape, and the like) has the hardness of 8,000 to 15,000 g and the springiness of 0.92 to 0.96 to achieve its use and purpose, and jelly contained in a container such as common plastic cups or plastic bags has the hardness of about 100 to 300 g and the springiness of 0.1 to 0.3, and thus it is difficult to maintain its intrinsic form.

In one embodiment of the present invention, the stick gel food is ingestible as a stick form as a certain stick form is maintained and it has springiness, and it is suitable that the stick gel food which satisfies the above conditions has the hardness of 400 to 2,000 g and the springiness of 0.6 to 0.9 measured at the temperature of 20° C.

Specifically, the hardness (g) of the stick gel type food of the present invention may be 400 to 2,000, 400 to 1,500, 400 to 1,000, 400 to 900, 500 to 1,500, 500 to 1,000, or 500 to 900. When the hardness of the stick gel food is excessively high, there is a problem of difficulty in soft intake, and when the hardness is low, it is difficult to maintain the stick form, and therefore it may be prepared by selecting the hardness range appropriately in consideration of intake easiness, form maintenance, and the like. The springiness of the stick gel food according to the present invention is 0.6 to 0.9, preferably 0.6 to 0.8, 0.65 to 0.85, 0.7 to 0.85, or 0.7 to 0.8.

The stick gel food of the present invention has the appropriate hardness to be easy to swallow or masticate, and requires characteristics such as gathering without scattering in the mouth, passing well when swallowing, and the like, and for example, it shows a soft gel phase form and may be easily sheared or destroyed. This has excellent food suitability and food texture that flows up to the throat without discomfort, for example, by pressing with a tongue, without masticating. In particular, the gel-type food of the present invention has the suitability and texture for food, although it contains the nutrients that have not been mixed in conventional soft drinks such as proteins and lipids and the like.

Conventional stick gel type foods tend to reduce intake convenience and lower sensory preferences of consumer, as the hardness and springiness are weakened and the syneresis (water release) is serious over time. Accordingly, it is preferable to improve physical properties in order to minimize changes of physical properties and syneresis even during distribution by maintaining the hardness at a certain level or more, compared to that of the initial production.

The present invention relates to a gel type food with improved physical properties, and preferably, the gel type food according to the present invention may has the hardness of 400 to 2,000 and the springiness of 0.6 to 0.9 measured at the temperature of 20° C., and additionally, the adhesiveness may be (−)25 to (−)30.

The gel type food according to the present invention may preferably have a difference in springiness of 0.03 or less and a difference in hardness of less than 65 g, which are measured after storing gel type foods in the packaged form in a thermo-hygrostat of 45° C. temperature and 80% relative humidity for 48 hours, based on the hardness and springiness measured at 25° C. right after preparation of gel type foods, and may maintain the hardness and springiness at an appropriate level over time. In addition, the water content of the gel type food measured after storing it in the packaged form in a thermo-hygrostat of 45° C. temperature and 80% relative humidity for 48 hours may be 55 to 68% by weight, based on 100% by weight of the total content of the total gel type food composition.

The water content means an amount of water comprised in foods, and the moisture in foods is always changed according to the surrounding environmental condition, and therefore the water activity considering the relative humidity in air is represented. The water activity is a very important characteristic in foods, as it is related to growth of microorganisms and chemical, biophysical and physical reactions in foods which change the flavor, color and scent of foods. The water activity is an essential characteristic of foods, and the equilibrium relative humidity is a characteristic in the environment in equilibrium with foods. The soft texture of food of products are better as the water content is high, but the high water content also has the high water activity and therefore there is a concern such as microorganism proliferation and the like, but the products of examples according to the present invention has the relatively high moisture content, but implements the soft texture of food and has the stability against microorganisms.

The gel type food composition according to the present invention comprises a gelling agent, and has the appropriate gelling ability and gel stabilizing ability, and it may provide the gel strength and syneresis desired to the gel obtained by its use, in particular, the gel strength and syneresis at a level capable of simply destroying with a tongue when ingesting. When it is outside of the appropriate content, the physical properties of the stick gel which is good intake convenience and reducing the bitter taste cannot be implemented, and it can be a reason why the bitter taste is more easily felt, and it increases syneresis causing inconvenience of falling down during ingesting, and there is possibility that the reduced production rate and the increased loss ratio of final products occur due to the problem of the temperature and viscosity of forming gel during the production of products.

Herein, the gelling agent is a polysaccharide having an ability of forming gel, and it may be usable in food engineering, processing and cooking. Examples of the gelling agent include agar, alginic acid, gelatin, carrageenan, pectin, Konjak, cellulose, gums and the like, and the gums may be at least one selected from the group consisting of xanthan gum, gellan gum, guar gum, locust bean gum, Arabic gum, pectin, tara gum and tamarind gum, and preferably, may comprise 2 kinds or more selected from the group consisting of xanthan gum, locust bean gum and carrageenan, and for example, may be 50 to 150 parts by weight, 90 to 110 parts by weight, or 95 to 105 parts by weight of locust bean gum, and 50 to 150 parts by weight, 90 to 140 parts by weight, or 100 to 150 parts by weight of carrageenan, based on 100 parts by weight of the solid content of xanthan gum.

The gel type food of the present invention is a gel type food which has excellent physical properties, in particular, with maintaining a certain form and having springiness and little syneresis during the storage and distribution, because of the combination of specific gelling agent, combination of the gelling agent and saccharides, and combination of their contents and the like.

When the pH of gel type foods is low, there may be a difficulty in gel formation and maintenance, because the gelling agent (gums) as the most important factor affecting the physical properties of gel type foods exhibits a large difference in the degree of gel formation and gel strength maintenance according to the pH condition. It is difficult to implement gel type foods which maintains a unique form of sticks, is soft and has less syneresis and an excellent mouth feel. Thus, it is required to select kinds of the gelling agent and control the content, and the like, for implementing the gel hardness, springiness, syneresis and mouth-feel, and the like, of gel type foods.

Locust bean gum and xanthan gum and the like have off-taste, and thus have a limit that it cannot be contained at a lot in preparation of jelly foods. As a commercially available gelling agent for preparation of gel type foods, carrageenan is usually used, since it has an advantage suitable for preparing flavorless and tasteless jelly foods due to no off-taste and off-flavor.

The gelling agent of the present invention may be included in an amount of 0.3 to 5% by weight, 0.3 to 4% by weight, 0.3 to 2.4% by weight, 0.3 to 1.8, 0.9 to 5% by weight, 0.9 to 4% by weight, 0.9 to 2.4% by weight, 0.9 to 1.8% by weight, 1.0 to 5% by weight, 1.0 to 4% by weight, 1.0 to 2.4% by weight, 1.0 to 1.8% by weight, 1.2 to 5% by weight, 1.2 to 4% by weight, 1.2 to 2.4% by weight, or 1.2 to 1.8% by weight, based on the solid weight of the gel type food composition.

The gel type food composition according to the present invention includes saccharides, and the saccharides comprise allulose essentially, with optionally additional saccharides.

The allulose may be added as crystalline allulose, non-crystalline allulose, allulose or allulose syrup. Allulose may be provided as powder or liquid, and it may be prepared by chemical and biological methods, or commercial allulose products may be purchased and used.

For example, the allulose syrup may be allulose-containing mixed saccharides or those obtained therefrom, and the mixed saccharides may be mixed saccharides prepared by reacting a composition for allulose production including at least one selected from the group consisting of allulose epimerase, microbial cells of a strain producing the enzyme, culture of the strain, lysates of the strain, and extracts of the lysates or culture, with a fructose-containing raw material, or those obtained therefrom. The syrup of mixed saccharides may be mixed saccharides including allulose 2 to 55 parts by weight, fructose 30 to 80 parts by weight, glucose 2 to 60 parts by weight, and oligosaccharides 0 to 15 parts by weight, based on 100 parts by weight of the total solid content, and the allulose raw sugar syrup may be obtained by separation and concentration processes from the mixed saccharides.

The allulose syrup passing through separation and purification processes in one embodiment of the present invention has the electrical conductivity of 1 to 50 μS/cm, and is liquid having colorless or light yellow sweetness, and it may be allulose-containing syrup including allulose of 5% by weight or more, or 10% by weight or more, and for example, the allulose-containing syrup may be allulose 5 to 99.9% by weight, 5 to 97% by weight, 5 to 95% by weight, 5 to 93% by weight, 5 to 90% by weight, 5 to 85% by weight, 5 to 80% by weight, 5 to 50% by weight, 5 to 30% by weight, 6.5 to 99.9% by weight, 6.5 to 97% by weight, 6.5 to 95% by weight, 6.5 to 93% by weight, 6.5 to 90% by weight, 6.5 to 85% by weight, 6.5 to 80% by weight, 6.5 to 50% by weight, 6.5 to 30% by weight, 9 to 99.9% by weight, 9 to 97% by weight, 9 to 95% by weight, 9 to 93% by weight, 9 to 90% by weight, 9 to 85% by weight, 9 to 80% by weight, 9 to 50% by weight, 9 to 30% by weight, 9 to 25% by weight, 9 to 20% by weight, 50 to 99.9% by weight, 50 to 97% by weight, 50 to 95% by weight, 50 to 93% by weight, 50 to 90% by weight, 50 to 85% by weight, 50 to 80% by weight, 70 to 99.9% by weight, 70 to 97% by weight, 70 to 95% by weight, 70 to 93% by weight, 70 to 90% by weight, 70 to 85% by weight, 70 to 80% by weight, 80 to 99.9% by weight, 80 to 97% by weight, 80 to 95% by weight, 80 to 93% by weight, 80 to 90% by weight, 80 to 85% by weight, 90 to 99.9% by weight, 90 to 97% by weight, 90 to 95% by weight, 90 to 93% by weight, 93 to 99.9% by weight, 93 to 97% by weight, 93 to 95% by weight, 95 to 99.9% by weight, or 95 to 97% by weight.

As one example for allulose preparation of the present invention, an expression system capable of producing psicose epimerase with high expression rate and stability, a GRAS (Generally recognized as safe) microorganism using it, and a method for producing psicose including the microorganism and enzyme using the expression system, and the like are described in detail in Korean Patent No. 10-1318422 and No. 10-1656063, and the like.

For the gel type food of the present invention, allulose may be added alone, or in addition, it may be comprised with one or more kinds of additional saccharides.

The example of the saccharides which can be added may include for example, common various kinds of saccharides containing monosaccharides (e.g. glucose, fructose) and disaccharides (e.g. at least one selected from the group consisting of lactose, maltose, isomaltose, turanose and trehalose, and the like), and it may be at least one selected from the group consisting of glucose, fructose and sugar. The allulose and saccharides including monosaccharides and disaccharides may be comprised in an amount of 1.0 to 30% by weight, 1.0 to 25% by weight, or 1.0 to 20% by weight, 2.5 to 30% by weight, 2.5 to 25% by weight, 2.5 to 20% by weight, preferably 5 to 30% by weight, 5 to 25% by weight, 5 to 20% by weight, 10 to 20% by weight, 10 to 25% by weight or 10 to 30% by weight, based on the total weight of the gel type food composition, respectively.

The gel type food composition according to the present invention may further comprise at least one selected from the group consisting of sugar-alcohols, dextrin and oligosaccharides, and for example, at least one selected from sugar-alcohols such as xylitol, sorbitol, maltitol, lactitol, inositol, erythritol, and the like; polysaccharides such as starch syrup, isomerized glucose syrup, dextrin, cyclodextrin, and the like; and oligosaccharides such as fructooligosaccharide, maltooligosaccharide, isomaltooligosaccharide, galactooligosaccharide, soy oligosaccharide, lactosucrose, and the like, etc. are included. The sugar-alcohols, dextrin and oligosaccharide may be provided as powder or liquid.

Herein, the total weight basis of the stick gel food composition is based on the total 100% by weight including powder ingredients and water, and it represents the solid content of each ingredient comprised in the composition in % by weight.

Based on the total weight of the gel type food composition, the sugar alcohols may be comprised in an amount of 5 to 30, preferably 10 to 20% by weight, and the oligosaccharide may be comprised in an amount of 0.5 to 20% by weight, 1 to 20% by weight, preferably 2 to 15% by weight, and the dextrin may be comprised in an amount of 1 to 20, preferably 2 to 10% by weight or 5 to 10% by weight, based on the solid weight of the gel type food composition.

The gel type food composition according to the present invention may comprise natural high intensity sweeteners such as sormatin, enzymatically modified stevia, stevia extracts or stevia glucoside (rebaudioside, etc.), glycyrrhizin, and the like, and synthetic high intensity sweeteners such as saccharin, sucralose, aspartame, and the like.

In one specific example, the saccharides of the gel type food composition comprise allulose and oligosaccharides, and additionally, it may further comprise at least one selected from the group consisting of sugar, sugar-alcohols, starch syrup and dextrin.

Based on the total % by weight of the gel type food composition, sugar-alcohols of 5 to 30% by weight, preferably 10 to 20% by weight, oligosaccharides of 1 to 20% by weight, preferably 5 to 10% by weight, and dextrin of 1 to 20% by weight, preferably 5 to 10% by weight may be comprised, and the gel type food composition may further comprise sugar of 1 to 30% by weight, preferably 5 to 20% by weight, based on the total % by weight. The total weight basis of the food composition means the content comprising powder ingredients and water.

The gel type food composition according to the present invention may be an acidic gel type food composition having a pH range of 2 to 6, and for example, may be pH 2 to 6, pH 3 to 6, pH 3.5 to 6, pH 4 to 6, or pH 4.5 to 6.

The gel type food composition according to the present invention may comprise at least one selected from the group consisting of anhydrous citric acid and vitamin C.

The stick gel food composition of the present invention may further include at least one selected from various nutrients, functional ingredients and preference ingredients, and the like.

The functional ingredients mean raw materials of ingredients having a function of diet, anti-aging, fatigue recovery, hangover cure, immunity enhancement, and the like, and specifically, it may be natural extracts, more specifically, extracts derived from plants, fruit or microorganisms, and may include yeast extracts, turmeric extracts, seaweed extracts, green tea extracts, pomegranate extracts, mango extracts, apple extracts, orange extracts, lemon extracts, and the like. The extracts may be solvent extracts using various solvents such as water, low carbon alcohol, and the like, or concentrates thereof, juice extraction (juice) of extracting plants and fruit and the like, juice extraction concentrates, or juice extraction powder, extract powder of the plants, fruit and microorganisms, or lysates in which the powder is dissolved in the solvent such as water, and there is no particular limit in preparation method and form thereof. The fruit may be used as a ground material or flesh.

The functional ingredients may be included in an amount of 5 to 20% by weight, preferably 10 to 15% by weight, based on the total weight of the gel type food composition.

As the nutrients, at least one selected from vitamins, amino acids, mineral components, and proteins, and the like may be included.

As the minerals (electrolytes and trace elements), common one, for example, sodium chloride, sodium acetate, magnesium sulfate, magnesium chloride, calcium chloride, potassium biphosphate, sodium monophosphate, calcium glycerophosphoric acid, iron and sodium succinate citrate, manganese sulfate, copper sulfate, zinc sulfate, sodium iodide, potassium sorbate, zinc, manganese, copper, iodide, cobalt, and the like, may be exemplified. The combination amount thereof may be suitably determined as needed.

The preference ingredients may comprise flavors for foods such as fruit flavor, flower flavor, mint flavor, vanilla flavor, cream flavor, chocolate flavor, caramel flavor, and the like, or natural products that are sources of the flavors in various forms such as concentrates or raw materials, and the like. Various kinds of artificial or natural flavors and colorings and the like for providing or improving the color and flavor may be further comprised. The preference ingredients comprise a seasoning, and the seasoning may be exemplified by coffee, matcha tea, peanut paste, almond paste, spice, cacao mass, cocoa powder, and the like.

The gel type food composition according to the present invention may further comprise at least one selected from the group consisting of yeast extracts, fruit extracts, organic acids and nutrients, in addition to a gelling agent and saccharides.

The yeast extracts may be comprised in an amount of 1 to 10% by weight, preferably 2 to 7% by weight, based on the solid weight of the gel type food composition.

The fruit extracts may comprise juice extraction of strawberries, green grapes, apples, oranges, lemons, mangoes, and the like, or concentrates of juice extraction, powder of juice extraction, solvent extracts, powder of extracts, or lysates of extracts. The fruit extracts may be comprised in an amount of 1 to 20% by weight, preferably 5 to 20% by weight, based on the solid weight of the gel type food composition.

The organic acids may be acetic acid, lactic acid, citric acid, tartaric acid, fumaric acid, succinic acid, malic acid, gluconic acid, adipic acid or phytic acid, and the nutrients may be at least one selected from the group consisting of vitamins, minerals (electrolytes and trace elements) and amino acids.

In addition, the gel type food composition of the present invention may not comprise an emulsifier and/or salts. Carrageenan cannot form stable gel under the condition of no inorganic salts, and about 50% to 70% of the gel tissue are destroyed during the process of preparation of jelly foods, and therefore the gel strength and elasticity are lost. However, addition of inorganic salts makes the preparation process complex, and deteriorates the quality of jelly foods due to unique off-taste and off-flavor of inorganic salts.

For preparation of the gel type food of the present invention, an appropriate additive may be further added and combined to a certain amount of each essential ingredient if needed. Herein, the additive to be added and combined if needed may be exemplified by coloring agents, flavoring agents, viscosity controlling agents, acidulants, seasonings, acidity controlling agents, food preservatives, stabilizers, grains, pulses, vegetables, glycerin, propanol, sodium phosphite, sodium naphthalenesulfonic acid, sodium laurinsulfonic acid, and the like.

As salt taste enhancers, sodium chloride (table salts) or potassium chloride, and the like may be exemplified. As viscosity controlling agents, whole egg, yolk, starch, gelatin, gum, and the like may be exemplified. As acidulants, acetic acid, lactic acid, citric acid, tartaric acid, fumaric acid, succinic acid, malic acid, gluconic acid, adipic acid, phytic acid, glucono-delta-lactone, ascorbic acid, and the like may be exemplified. As seasonings, coffee, matcha tea, peanut paste, almond paste, spice, cacao mass, cocoa powder, and the like may be exemplified. As acidity controlling agents, anti-oxidants, sodium acetate, sodium citrate, sodium malate, sodium tartaric acid, sodium succinate, sodium fumarate, and the like may be exemplified. As food preservatives, coloring agents, sorbic acid, potassium sorbate, sodium sorbate, ethyl alcohol, and the like may be exemplified. These may be used as one kind alone or in combination of two kinds or more. The combination ratio of these additives is not particularly limited, but commonly, it is general to be selected in the range to 20 parts by weight based on 100 parts by weight of the food of the present invention.

An embodiment of the present invention relates to a preparation method of stick gel comprising a step of heat stirring a mixed solution of gums and saccharides at a high temperature of 80° C. or more and then cooling it in a cool well of 10° C. to solidify.

The preparation method may further comprise one or more kinds of steps selected from the group consisting of filling the mixed solution in a package material and conducting microorganism sterilization treatment.

Specifically, it comprises (1) dissolving gums in water; (2) adding and dissolving saccharides to the resulting solution of the above step; and (3) cooling and gelling the resulting mixed solution of the above step. Hereinafter, in consideration of specific examples of the present invention, the preparation method of acidic gel type foods will be described in detail.

In the (1) step, the amount of mixture of water (for example, distilled water) and gums to be dissolved may be 0.3 to 5.0% by weight, based on the 100% by weight of the total final mixture. Dissolution of the mixture of gums may be performed while stirring under the heat condition (for example, to 85° C.), and then the gums may be lumped without loosening when added at once, and therefore it is preferable to add them as divided in a small amount.

When the (1) step is completed, preferably stirring is continued and saccharides are added to the resulting solution [(2) step]. The amount of saccharides to be added may be 1-30% by weight based on 100% by weight of the total final composition, and more preferably, it may be 5-20% by weight.

When the (2) step is completed, the resulting solution is gelled [(3) step]. Gelling may be performed by cooling, and specifically, it may be conducted by cooling the resulting solution of (2) step in a cool well at a low temperature (for example, 10° C.). When the gel type food of the present invention is prepared in stick-packed or cup-shaped containers, before cooling, the resulting solution of (2) step is added to the stick-packed or cup-shaped containers and is sealed, and then is added to the cool well. If needed, after seal packing, it may be added to the cool well after heat sterilization is conducted in a hot well at a high temperature (for example, 80° C.).

The gel solution may be packaged in a container to produce the stick gel. When the container may be a stick-type pouch or cup form, or the like, the gel is formed and has to be maintained for the strength and elasticity, after the solution for gel type food is filled and packaged in a container. Such a gel type food, in particular, is differently classified by physical properties with general jelly such as gummy and the like, and the gel type food has the weak gel strength than the general jelly, but the gel form is maintained in the container due to the elastic property.

A desired gel-like food product can be obtained by filling in a proper container and sterilizing according to a common method. The sterilization may be conducted by heat sterilization or sterile filtration and the like according to a common method. When heat sterilization process is adopted as the sterilization process, this combines heat process, and therefore the heat process before the sterilization manipulation is unnecessary. When sterilization process not accompanying heating is adopted, the heat manipulation is needed before the sterilization manipulation. The heat process may be conducted under the same condition as the commonly adopted heat sterilization process.

### Advantageous Effects

The gel composition with improved physical properties and a gel type food prepared therefrom according to the present invention have characteristics of less syneresis, maintaining a certain shape in a packaged form, and having hardness and springiness at a certain level or more. A gel type food with good texture and flavor due to low-calorie, storage stability, less syneresis, hardness and springiness can be provided.

### BRIEF DESCRIPTION OF THE DRAWINGS

FIG. 1 and FIG. 2 show photographs of mixed samples for preparing gel type foods it is containing various fruit concentrates according to the present invention.

FIG. 3 is a graph showing the result of analyzing mixed solutions for preparing gel type foods containing various fruit concentrates by an electronic tongue analyzer according to the present invention.

FIG. 4 shows photographs of mixed samples for preparing gel type foods containing fruit concentrates in which two kinds of mango concentrates are mixed according to the present invention.

FIG. 5 is a graph showing the result of analyzing mixed samples for preparing gel type foods including fruit concentrates in which two kinds of mango concentrates are mixed by an electronic tongue analyzer according to the present invention.

FIG. 6 is a photograph showing the result of evaluating the water-holding property of gel type foods according to the present invention and the comparative sample.

FIG. 7 is a photograph of gel type foods taken at the day of preparation of gel type foods and 2 days later under the severe condition of 45° C. temperature, in order to evaluate the syneresis of gel type foods according to the present invention and the comparative sample.

FIG. 8 is a photograph confirming mold proliferation as a result of leaving gel type foods according to the present invention and the comparative sample at a room temperature for 1 week after preparation of gel type foods.

### DETAILED DESCRIPTION OF THE EMBODIMENTS

The present invention will be described in more detain by the following examples, but the scope of the present invention is not intended to be limited in the range of the following exemplary examples.

Hereinafter, in order to describe the present invention in more detail, examples are included. In addition, in each example, “part” and “%” represent “part by weight” and “% by weight” unless otherwise specified.

### Example 1: Preparation of Stick Gel Foods

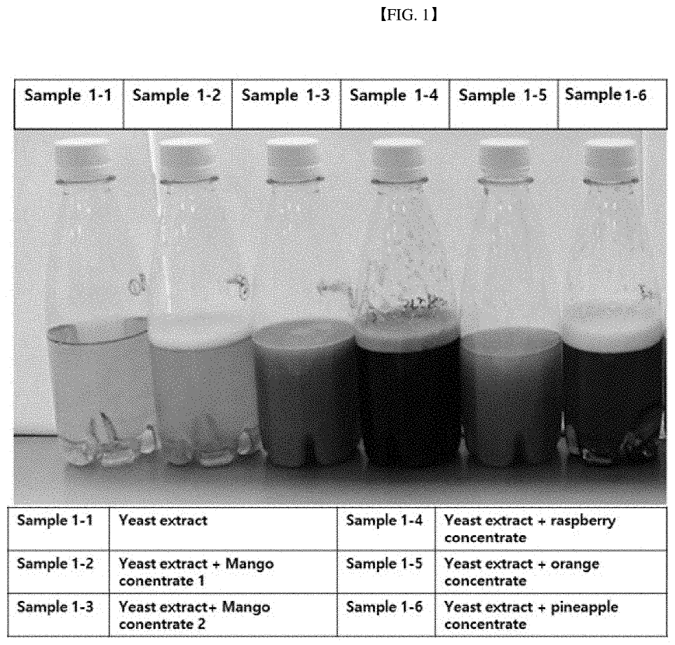

Various fruit concentrates (same fit to 14.3% overall) were added to water at a certain ratio and were put in a container, and while stirring at a speed of 200 rpm, mixture powders of xanthan gum, locust bean gum and carrageenan were added, and heating started. Then, gums were added as divided into small amounts. When the temperature of the solution reached 85° C., a mixed solution was prepared by adding powder raw materials such as saccharides, yeast extracts, vitamin C and the like while stirring. FIG. 1 and FIG. 2 show photographs of mixed samples for preparing gel type foods comprising various fruit concentrates according to the present invention.

The mixed solution 18 g was filled into a stick packing material, and after performing heat sterilization in an 85° C. hot well for 30 minutes, it was gelled by cooling in a 10° C. cool well to prepare stick gel foods.

Allulose powder with 99.7% purity was purchased and used, and stick gel foods were prepared with the composition of increasing the allulose content gradually. The products used in the following Table 1, white sugar, xylitol and fructooligosaccharide of Samyang company products were used. As the fructooligosaccharide, fructooligosaccharide syrup having the fructooligosaccharide content of 60% by weight and the solid content of 75 Brix, based on the 100% by weight of total solid of saccharides was used.

All Sample 1-2 to Sample 1-11 comprised the same content of the various fruit concentrates used in the following Table 1, but Sample 1-2 was mango concentrates 1 (clear type), and Sample 1-3 was mango concentrates 2 (cloudy type), and Sample 1-4 was raspberry concentrates, and Sample 1-5 was orange concentrates, and Sample 1-6 was pineapple concentrates, and Sample 1-7 was citron concentrates, and Sample 1-8 was strawberry concentrates, and Sample 1-9 was apple concentrates, and Sample 1-10 was banana concentrates, and Sample 1-11 was peach concentrates. Sample 1-1 was prepared by the same method except for not containing fruit concentrates. Photographs of prepared samples were shown in FIG. 1 (Samples 1-1 to 1-6) and FIG. 2 (Samples 1-7 to 1-11), respectively. The mango concentrates 1 are obtained by additionally performing a process of removing fibers after preparing concentrates as a clear type (transparent) and mango concentrates 2 are cloudy type (non-transparent) concentrates without performing a fiber removing process.

TABLE 1

| | | Sample 1-2 to |
|---|---|---|
| Raw material name | Sample 1-1 | Sample 1-11 |
| Yeast extracts | 2.550 | 2.550 |
| Xanthan gum | 0.450 | 0.450 |
| Locust bean gum | 0.450 | 0.450 |
| Carrageenan | 0.450 | 0.450 |
| Turmeric powder | 0.450 | 0.450 |
| Citric acid | 0.250 | 0.250 |
| White sugar | 5.000 | 5.000 |
| Vitamin | 1.200 | 1.200 |
| Crystalline | 4.000 | 4.000 |
| fructose | | |
| Xylitol | 5.000 | 5.000 |
| Fructooligosaccharide | 20.3 | 6.0 |
| Fruit concentrates | 0 | 14.3 |
| Flavor | 2.000 | 2.000 |
| Water | 57.900 | 57.900 |
| Total | 100.000 | 100.000 |

Besides the sensory evaluation result tested by human, to obtain the objective data of sensory change, a device, ‘electronic tongue’ was used in analysis. Specifically, the mixed solutions used for preparing stick gel type food in the Samples 1-1 to 1-11 were used as samples for electronic tongue analysis,

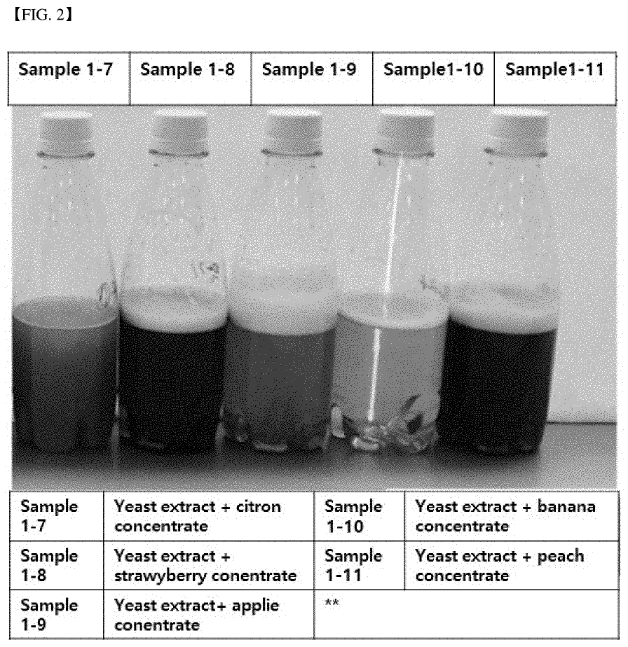

An electronic tongue (Astree, Alpha MOS Ltd., Toulouse, France) was used to analyze tastes of samples, and as a reference electrode, Ag/AgCl was used, and a module with 7 sensors (Sensor array #6, Alpha MOS, Toulouse, France) was used. 100 mL of samples diluted 10 times with water were put in glass containers and analysis was conducted using an automatic sample measuring instrument. Each sample was measured for 120 seconds, and between each sample, sensors were washed with distilled water for 10 seconds to prevent contamination. The sensor measurement values of each sample were converted into respective taste values, and the measurement was repeated 5 times in total and the mean values were used. In statistical treatment of measured values, the software provided from Alpha MOS (Alpha soft 14.1 version, Alpha MOS, Toulouse, France) was used. The measurement result is shown in FIG. 3.

The electronic tongue analysis is a relative measured value, and in consideration of the graph of FIG. 3, the t contribution rate of longitudinal axis is 0.04973% and the contribution rate of horizontal axis is 99.937%, and therefore masking of fermented rice of yeast extracts is analyzed to be affected mainly by the longitudinal axis. Seeing the electronic tongue analysis result of analysis samples, Sample 1-1 not comprising fruit concentrates is positioned in the right of the graph, and therefore the farther from the position of Sample 1-1 based on the longitudinal axis is, it means that it is different from the taste of yeast extracts, and it is interpreted that unfavorable sensory of yeast extracts, for example, the effect of masking of fermented rice is increased. Specifically, it could be confirmed that among analysis samples, Sample 1-9 (apple concentrates) had the lowest masking effect and mango concentrates had the highest masking effect.

### Example 2: Preparation of Stick Gel Foods

Mixed solutions were prepared by the substantially same method as Example 1, but were prepared by mixing mango concentrates 2 (cloudy type) to water at a certain ratio according to the ingredients and compositions disclosed in the following Table 2.

The mixed solution 18 g was filled into a stick packing material, and after performing heat sterilization in an 85° C. hot well for 30 minutes, it was gelled by cooling in a 10° C. cool well to prepare stick gel foods.

Specifically, the sample preparation and analysis method for electronic tongue analysis was substantially same as Example 1 to perform the electronic tongue analysis.

TABLE 2

| Ingredients | Sample 2-1 | Sample 2-2 | Sample 2-3 | Sample 2-4 | Sample 2-5 |
|---|---|---|---|---|---|
| Allulose | 3.00 | 5.00 | 10.00 | 15.00 | 23.00 |
| Xylitol | 8.00 | 6.00 | 1.00 | 0 | 0 |
| White sugar | 7.00 | 7.00 | 7.00 | 3.00 | 0 |
| Fructooligosaccharide | 5.00 | 5.00 | 5.00 | 5.00 | 0 |
| Yeast extract powder | 2.85 | 2.85 | 2.85 | 2.85 | 2.85 |
| Vitamin C | 1.165 | 1.165 | 1.165 | 1.165 | 1.165 |
| Xanthan gum | 0.60 | 0.60 | 0.60 | 0.60 | 0.60 |
| Locust bean gum | 0.60 | 0.60 | 0.60 | 0.60 | 0.60 |
| Carrageenan | 0.60 | 0.60 | 0.60 | 0.60 | 0.60 |
| Turmeric extract powder | 0.45 | 0.45 | 0.45 | 0.45 | 0.45 |
| Mango concentrates | 14.30 | 14.30 | 14.30 | 14.30 | 14.30 |
| Distilled water | 56.435 | 56.435 | 56.435 | 56.435 | 56.435 |
| Total (% by weight) | 100.00 | 100.00 | 100.00 | 100.00 | 100.00 |

According to the ingredients and contents shown in the following Table 3, comparative samples not comprising allulose were prepared. Specifically, Samples 2-6 to 2-9 comprised sugar, erythritol, crystalline fructose or fructooligosaccharides, respectively, as a single saccharide, and Sample 2-10 comprised fructose, fructooligosaccharides and dextrin, and gel foods were prepared by the substantially same method as Example 1.

TABLE 3

| Ingredients | Sample 2-6 | Sample 2-7 | Sample 2-8 | Sample 2-9 | Sample 2-10 |
|---|---|---|---|---|---|
| White sugar | 23.00 | — | — | — | — |
| Erythritol | — | 23.00 | — | — | — |
| Crystalline fructose | — | — | 23.00 | — | 15.5 |
| Fructooligosaccharide | — | — | — | 23.00 | 5.00 |
| Dextrin | — | — | — | — | 2.50 |
| Yeast extract powder | 2.850 | 2.850 | 2.850 | 2.850 | 2.850 |
| Vitamin C | 1.165 | 1.165 | 1.165 | 1.165 | 1.165 |
| Xanthan gum | 0.600 | 0.600 | 0.600 | 0.600 | 0.600 |
| Locust bean gum | 0.600 | 0.600 | 0.600 | 0.600 | 0.600 |
| Carrageenan | 0.600 | 0.600 | 0.600 | 0.600 | 0.600 |
| Turmeric extract powder | 0.450 | 0.450 | 0.450 | 0.450 | 0.450 |
| Mango concentrates | 14.300 | 14.300 | 14.300 | 14.300 | 14.300 |
| Distilled water | 56.435 | 56.435 | 56.435 | 56.435 | 56.435 |
| Total (% by weight) | 100.00 | 100.00 | 100.00 | 100.00 | 100.00 |

### Example 3

According to the ingredients and contents shown in the following Table 4, stick gel foods of Sample 3-1 comprising allulose and sugar, Sample 3-2 comprising allulose powders alone, and Sample 3-3 comprising allulose powders, fructooligosaccharides and dextrin, were prepared by the substantially same method as Example 1.

TABLE 4

| Ingredients | Sample 3-1 | Sample 3-2 | Sample 3-3 |
|---|---|---|---|
| Allulose powder | 10.00 | 23.00 | 2.50 |
| White sugar | 13.00 | — | — |
| Fructooligosacchride | — | — | 5.00 |
| Dextrin | — | — | 15.50 |
| Yeast extract | 2.850 | 2.850 | 2.850 |
| powder | | | |
| Vitamin C | 1.165 | 1.165 | 1.165 |
| Xanthan gum | 0.600 | 0.600 | 0.600 |
| Locust bean gum | 0.600 | 0.600 | 0.600 |
| Carrageenan | 0.600 | 0.600 | 0.600 |
| Turmeric extract | 0.450 | 0.450 | 0.450 |
| powder | | | |
| Mango | 14.300 | 14.300 | 14.300 |
| concentrates | | | |
| Distilled water | 56.435 | 56.435 | 56.435 |
| Total (% by | 100.00 | 100.00 | 100.00 |
| weight) | | | |

### Example 4: Preparation of Stick Gel Foods

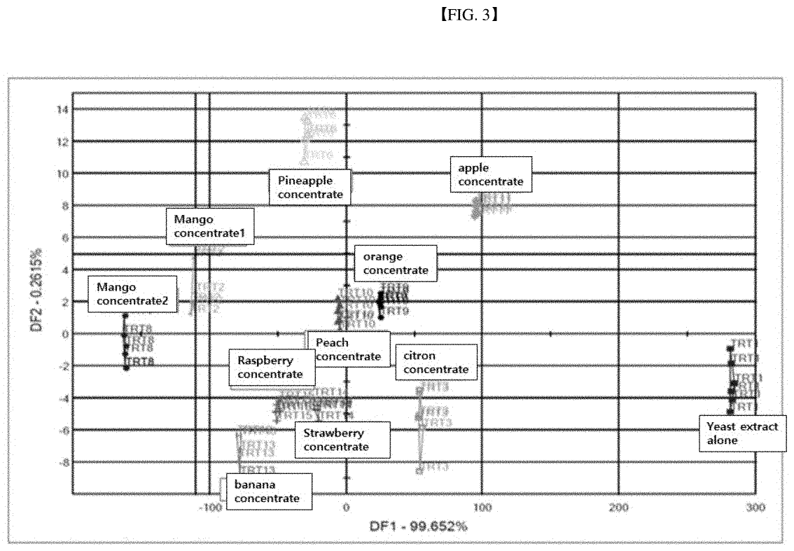

Mixed solutions were prepared by the substantially same method as Example 1, but were prepared by mixing mango concentrates 1 (clear type) and mango concentrates 2 (cloudy type) as fruit concentrates by 10.0:4.3 (Sample 4-1), 7.0:7.3 (Sample 4-2) and 4.3:10.0 (Sample 4-3). FIG. 4 shows photographs of mixed samples for preparation of gel type foods comprising fruit concentrates in which two kinds of mango concentrates are mixed according to the present invention.

The mixed solution 18 g was filled into a stick packing material, and after performing heat sterilization in an 85° C. hot well for 30 minutes, it was gelled by cooling in a 10° C. cool well to prepare stick gel foods.

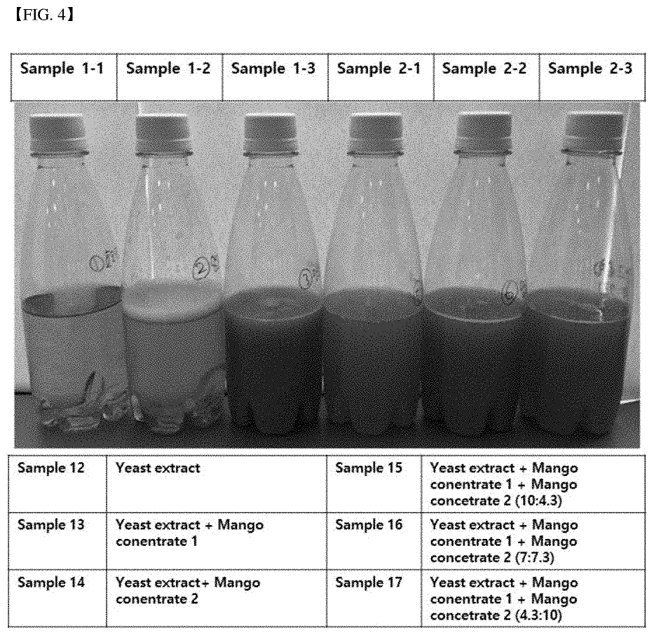

Specifically, the sample preparation and analysis method for electronic tongue analysis was substantially same as Example 1 to perform the electronic tongue analysis. The result was shown in FIG. 5.

TABLE 5

| Raw material | Sample | Sample | Sample | Sample | Sample | Sample |
|---|---|---|---|---|---|---|
| name | 1-1 | 1-2 | 1-3 | 2-1 | 2-2 | 2-3 |
| Yeast extract | 2.550 | 2.550 | 2.550 | 2.550 | 2.550 | 2.550 |
| Xanthan gum | 0.450 | 0.450 | 0.450 | 0.450 | 0.450 | 0.450 |
| Locust bean | 0.450 | 0.450 | 0.450 | 0.450 | 0.450 | 0.450 |
| gum | | | | | | |
| Carrageenan | 0.450 | 0.450 | 0.450 | 0.450 | 0.450 | 0.450 |
| Turmeric | 0.450 | 0.450 | 0.450 | 0.450 | 0.450 | 0.450 |
| powder | | | | | | |
| Citric acid | 0.250 | 0.250 | 0.250 | 0.250 | 0.250 | 0.250 |
| White sugar | 5.000 | 5.000 | 5.000 | 5.000 | 5.000 | 5.000 |
| Vitamin | 1.200 | 1.200 | 1.200 | 1.200 | 1.200 | 1.200 |
| Crystalline | 4.000 | 4.000 | 4.000 | 4.000 | 4.000 | 4.000 |
| fructose | | | | | | |
| Xylitol | 5.000 | 5.000 | 5.000 | 5.000 | 5.000 | 5.000 |
| Fructooligosac- | 20.3 | 6.0 | 6.0 | 6.0 | 6.0 | 6.0 |
| charide | | | | | | |
| Mango | 0 | 14.3 | 0 | 10.0 | 7.0 | 4.3 |
| concentrates 1 | | | | | | |
| Mango | 0 | 0 | 14.3 | 4.3 | 7.3 | 10.0 |
| concentrates 2 | | | | | | |
| Flavor | 2.000 | 2.000 | 2.000 | 2.000 | 2.000 | 2.000 |
| Water | 57.900 | 57.900 | 57.900 | 57.900 | 57.900 | 57.900 |
| Total | 100 | 100 | 100 | 100 | 100 | 100 |

The electronic tongue analysis is a relative measured value, and in consideration of the graph of FIG. 5, the t contribution rate of longitudinal axis is 0.04973% and the contribution rate of horizontal axis is 99.937%, and therefore masking of fermented rice of yeast extracts is analyzed to be affected mainly by the longitudinal axis. Seeing the electronic tongue analysis result of analysis samples, in samples comprising mango concentrates 1 (clear type) or mango concentrates 2 (cloudy type) alone, the effect of masking unfavorable tastes of yeast extracts was demonstrated, compared to samples comprising only yeast extracts of Sample 1-1, but it was confirmed that the case of mixing and using mango concentrates 1 (clear type) and mango concentrates 2 (cloudy type) was more preferable. In addition, in case of mixing and using mango concentrates 1 (clear type) and mango concentrates 2 (cloudy type), in case that the mixing weight ratio was 7.0:7.3 (Sample 4-2), the effect was the highest, and Sample 4-3 containing higher amount of mango concentrates 2 (mixing weight ratio=4.3:10.0) was positioned in the left compared to Sample 4-1 containing lower amount of mango concentrates 2, and therefore it was present in the farther position from yeast extracts, and thus it is interpreted that unfavorable sensory of yeast extracts. For example, the effect of masking fermented rice is increased. Specifically, it could be confirmed that the sample having the mixing weight ratio of 7.0:7.3 (Sample 4-2) showed the highest masking effect among the analyzed samples.

### Experimental Example 1: Evaluation of Physical Properties of Stick Gel Foods

Right after preparing stick gel foods according to Example 2, physical properties of stick gel foods were evaluated by the following method. Specifically, as samples for evaluation of physical properties, stick gel foods of which package material was opened right after preparation were cut into 1 cm size in all width, length and height, and hardness (g), adhesiveness (unit gs), and springiness (no unit) were tested (Two Bite Test) using a TA (Texture Analyzer).

The hardness is a force required for a probe (circle, diameter 36 mm) for physical property measurement to touch a sample and reach a desired deformation, and the hardness was measured based on the weight (g) to the maximum force shown in the first compression process, and the springiness is a property of the modified sample to return to the original condition after the force is removed, and the springiness was measured by differences between the first applied force and time when secondarily compressing by the same strength after the first compression. The adhesiveness is shown as gs by measuring the degree to which the sample is attached to the probe when compression is released after compression, and the experimental result was shown in the following Table 6 and Table 7.

### Experimental Example 2: Evaluation of Syneresis of Stick Gel Foods

Five expert researchers who have conducted research on formulations of stick gel foods, as evaluation subjects, divided the syneresis of gel type foods into 5 stages according to the degree, and almost no syneresis was represented by stage 1, and as the number increased, the degree of syneresis was severe.

The stick gel analysis result of Example 2 and the experimental result of Samples 2-6 to 2-10 were shown in the following Table 6 and Table 7, respectively.

TABLE 6

| Classification | Sample 2-1 | Sample 2-2 | Sample 2-3 | Sample 2.4 | Sample 2-5 |
|---|---|---|---|---|---|
| Hardness | 679.7 | 672.35 | 689.5 | 717.15 | 740.37 |
| (g) | | | | | |
| Adhesiveness | −26.43 | −26.34 | −26.87 | −27.15 | −28.45 |
| (gs) | | | | | |
| Springiness | 0.75 | 0.751 | 0.747 | 0.752 | 0.757 |
| Degree of | 3 | 3 | 3 | 3 | 2 |
| syneresis | | | | | |

As shown in the Table 6, it was confirmed that Samples 2-1 to 2-5 of Example 2 had the increased hardness because of the increased allulose content, and Sample 2-5 comprising allulose powders alone obtained in Example 2, the syneresis was reduced.

In addition, when ingesting the stick gel of Example 2, the sensory preference increased due to the increased allulose content. The result was caused by the reduced off-taste, and increased texture preference due to the increased hardness. The stick gel food of the present invention obtained above had a uniformly smooth surface condition in appearance, and the gel form could be destroyed only by pressing it with a tongue in the mouth, and it showed a soft gel phase to be easily masticated even with little power.

TABLE 7

| Classification | Sample 2-6 | Sample 2-7 | Sample 2-8 | Sample 2-9 | Sample 2-10 |
|---|---|---|---|---|---|
| Hardness (g) | 738.64 | 733.88 | 588.11 | 737.87 | 626.61 |
| Adhesiveness (gs) | −26.52 | −25.94 | −25.84 | −25.98 | −25.72 |
| Springiness | 0.757 | 0.74 | 0.72 | 0.752 | 0.741 |
| Degree of syneresis | 2 | 3 | 4 | 2 | 3 |

As shown in the Table 7, it was the result of evaluating the degree of occurrence of off-taste and/or off-flavor in samples after storage under the severe conditions, and the hardness of the sample applying allulose was the lowest compared to Sample 2-8 applying crystalline fructose, and the level of reducing the hardness was increased and the springiness was reduced according to the severe storage.

### Experimental Example 3: Evaluation of Water-Holding Property of Stick Gel Foods

(1) Evaluation for the Samples Obtained in Example 2

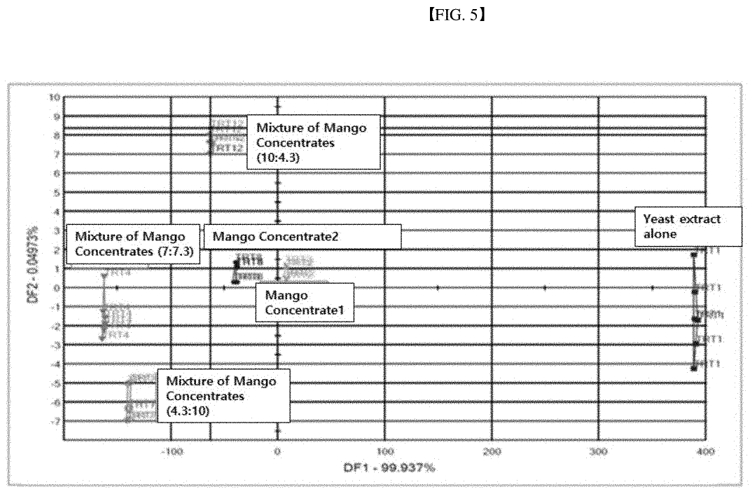

For Sample 2-3 and Sample 2-5 using allulose and Sample 2-7 using erythritol obtained in Example 2, while the package material was removed and contents were exposed, they were left under the conditions of 20° C. room temperature and 60% relative humidity for 24 hours, and then the surface dry level was confirmed. FIG. 6 is a photograph showing the result of water-holding property evaluation of samples.

As shown in FIG. 6, in case of Sample 2-7 applied with erythritol, the surface was dried fastest and was hardened toughly, and therefore the springiness, hardness and the like were risen, and Sample 2-4 and Sample 2-5 had low springiness and hardness and the like due to slow drying rate, and thus Sample 2-7 was more preferable to be taken to the product level.

(2) Evaluation for Samples Obtained in Example 3

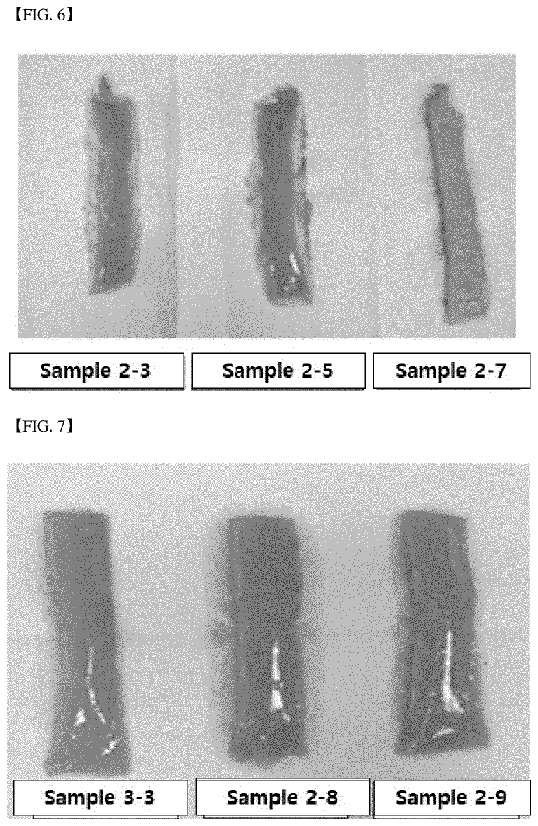

For Sample 3-3 mixing and using allulose and fructooligosaccharides obtained in Example 3, Sample 2-8 using crystalline fructose and Sample 2-9 using fructooligosaccharides, a photograph of stick gel taken at the day of preparation of stick gel foods was shown. In FIG. 7, the result of evaluation of the water release for Sample 3-3 of Example 3 and Samples 2-8 and 2-9 was shown.

As shown in FIG. 7, it was confirmed that there was little syneresis when using fructose of Sample 2-8, but stick gel foods mixing and using allulose and fructooligosaccharides such as Sample 3-3 were more preferable due to the water release.

### Experimental Example 4: Evaluation of Physical Properties, Syneresis and Sensory of Stick Gel

For Sample 3-2, Sample 3-2 and Sample 3-3 obtained in Example 3, by the substantially same method as the method according to Experimental examples 1 and 2, physical properties (hardness, adhesiveness, springiness) and syneresis were conducted, and the result was shown in the following Table 8.

In addition, for sensory evaluation, 5 sensory test personnel having 5 years of more of sensory test experience in the food-related field (gel type foods) performed overall preference evaluation by conducting the sensory test on a 5-point scale. The overall preference was evaluated based on presence of off-taste and off-flavor of raw materials (for example, yeast extracts) applied in combination as priority sensory test items, and besides, the preference of texture of stick gel foods when ingesting was additionally evaluated. The sensory evaluation standard was as follows.

Sensory evaluation standard: off-taste/off-flavor occurrence (0)˜no off-taste/off-flavor occurrence (5)

The sensory of stick gel was evaluated by the following method right after preparing the stick gel according to Example 3. Specifically, as the sensory evaluation method, the sensory evaluation was performed by cutting stick gel right after preparation, and stick gel of which package material was opened into 1 cm size in all width, length and height, and the result was shown in the following Table 8.

In other words, Table 8 shows the result of evaluating the stick gel foods of which package was opened right after preparation.

TABLE 8

| Ingredients | Sample 3-1 | Sample 3-2 | Sample 3-3 |
|---|---|---|---|
| Hardness (g) | 727.83 | 714.11 | 714.67 |
| Adhesiveness (gs) | −25.89 | −-25.77 | −26.02 |
| Springiness | 0.737 | 0.747 | 0.746 |
| Syneresis | 2 | 2 | 2 |
| Sensory evaluation | 4.3 | 4.5 | 4.2 |

### Experimental Example 5: Evaluation of Changes in Physical Properties with Storage Period

At the time right after preparation under the measurement condition of 25° C. for the stick gel obtained in Sample 3-2 and Sample 3-3 in Example 3, and Samples 2-6 to 2-9 in Example 2, and after storing the stick gels in the package for 48 hours in a thermo-hygrostat of 45° C. temperature (severe condition) and relative humidity 80%, for 48 hours, the hardness and springiness were evaluated by the same method as Experimental example 1. The difference between the measured hardness and springiness was summarized in the following Table 9.

TABLE 9

| | | Difference of | | Difference of |
|---|---|---|---|---|
| | Hardness | hardness (g) | | springiness (gs) |
| | measured | measured after | Springiness | measured after |
| | at | storage under | measured | severe |
| | right | the severe | right | condition |
| | after | condition and | after | storage and |
| | prepara- | right after | preparation | right after |
| assortment | tion (g) | preparation | (gs) | preparation |
| Sample 3-2 | 714.11 | 61.8 | 0.747 | 0.015 |
| Sample 3-3 | 714.67 | 52.0 | 0.746 | 0.008 |
| Sample 2-6 | 738.64 | 100.2 | 0.757 | 0.020 |
| Sample 2-7 | 733.88 | 64.0 | 0.740 | 0.005 |
| Sample 2-8 | 588.11 | 79.0 | 0.720 | 0.008 |
| Sample 2-9 | 737.87 | 200.0 | 0.752 | 0.021 |

As shown in the Table 9, the smaller the difference between the hardness and springiness of the stick gels at the time right after preparation and storage under the severe condition storage, it can be the stick gel having more preferable physical properties. It was confirmed that Sample 3-2 and Sample 3-3 in Example 3 of the present application were easily produced as the final product due to physical properties equal to those of the stick gel of Samples 2-6 to 2-9, and in particular, they showed preferable physical properties due to the equal difference of the hardness and springiness of right after preparation and storage condition, compared to Sample 2-7 containing erythritol and Sample 2-8 containing fructose.

In addition, for Sample 3-3 in Example 3 and Samples 2-8 and 2-9, after being stored for 48 hours as packaged in the package material in a thermo-hygrostat of 45° C. temperature (severe condition) and relative humidity 80%, the water content (%) was measured with a moisture analyzer (Satoriuns, Germany) by weighing sample 2 g and setting the temperature to 105° C. and time to automatic mode.

As the result of water content measurement, the water content of Sample 3-3 was 64.12%, and Sample 2-8 containing fructose was 62.85%, and Sample 2-9 containing fructooligosaccharide was 64.25%.

### Experimental Example 6: Evaluation of Storage Stability

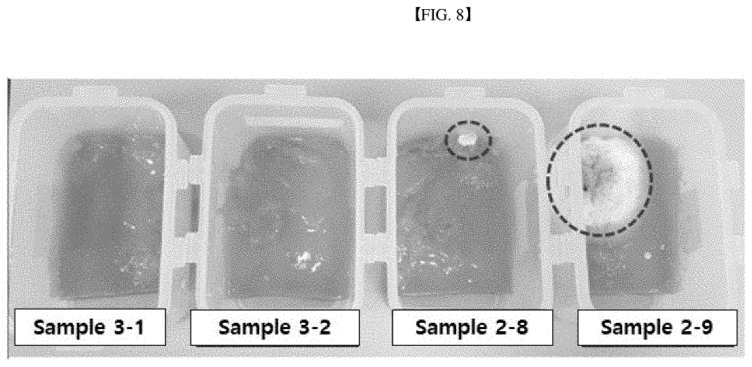

After leaving the stick gel foods in Sample 3-2 and Sample 3-2 of Example 3 and Sample 2-8 and Sample 2-9 at a room temperature for 1 week after preparation, the mold proliferation was evaluated with naked eyes, and the result was shown in FIG. 8. FIG. 8 is a photograph confirming the mold proliferation as a result of leaving stick gel foods at a room temperature for 1 week after preparation.

As shown in FIG. 8, it could be confirmed that the stick gel foods of Sample 3-1 and Sample 3-2 had excellent storage stability against microorganisms, particularly, molds, despite of relatively high moisture content. The soft texture of food is better as the water content is high, but the high water content also has the high water activity, and therefore there is a concern such as microorganism proliferation and the like, but the products of examples according to the present invention has the relatively high moisture content, but implements the soft texture of food and has the stability against microorganisms.

1. A stick gel type food composition comprising yeast extracts, fruit extracts and gelling agent.

2. The stick gel type food composition according to claim 1, wherein the stick gel type food composition has the springiness of 0.6 to 0.9 and the hardness of 400 to 2,000 g which are measured by a texture analyzer.

3. The stick gel type food composition according to claim 1, wherein the stick gel type food composition further comprises at least one selected from the group consisting of monosaccharides, disaccharides, sugar-alcohols, oligosaccharides and dextrin.

4. (canceled)

5. The stick gel type food composition according to claim 1, wherein the fruit extracts are extracts, concentrates or processed products of the concentrates of at least one selected from the group consisting of mangoes, bananas, raspberries, strawberries, pineapples, peaches, oranges, lemons, citrons and apples.

6. The stick gel type food composition according to claim 1, further comprising at least one selected from the group consisting of turmeric extracts, seaweed extracts and green tea extracts.

7. The stick gel type food composition according to claim 1, wherein the gelling agent is at least one selected from the group consisting of agar, alginic acid, gelatin, carrageenan, pectin, Konjak, cellulose and gums.

8. (canceled)

9. The stick gel type food composition according to claim 1, wherein the water content of the stick gel type food composition is 55 to 68% by weight based on the total weight of the stick gel type food composition.

10. The stick gel type food composition according to claim 1, wherein the pH range is 3.5 to 6.

11. The stick gel type food composition according to claim 1, wherein one or more kinds selected from the group consisting of monosaccharides, disaccharides, sugar-alcohols, oligosaccharides and dextrin are comprised in an amount of 1.0 to 30% by weight, based on the total weight of the food composition, and the solid content of gelling agent is 0.3 to 5% by weight.

12. The stick gel type food composition according to claim 1, wherein 1.0 to 10% by weight of the yeast extracts and 1 to 20% by weight of mango extracts are contained.

13. The stick gel type food composition according to claim 3, wherein the monosaccharide is allulose, and the allulose is added as at least one selected from the group consisting of crystalline allulose, non-crystalline allulose and allulose syrup.

14. The stick gel type food composition according to claim 1, further comprising a high intensity sweetener.

15. The stick gel type food composition according to claim 1, not comprising at least one selected from the group consisting of emulsifiers, salts, flavors, organic acids, vitamins, amino acids and minerals.

16. A stick gel type food composition comprising a gelling agent and allulose,
wherein the stick gel type food composition has the springiness of 0.6 to 0.9 and the hardness of 400 to 2,000 g which are measured by a texture analyzer.

17. The stick gel type food composition according to claim 16, wherein the solid content of saccharides comprising allulose is 1.0 to 30% by weight and the solid content of the gelling agent is 0.3 to 5% by weight, based on the total weight of the food composition.

18. The stick gel type food composition according to claim 16, wherein the solid content of allulose is 1.0 to 25% by weight and the gelling agent is 0.3 to 5% by weight, based on the total weight of the composition.

19-24. (canceled)

25. The stick gel type food composition according to claim 16, not comprising at least one selected from the group consisting of emulsifiers, salts, flavors, organic acids, vitamins, amino acids and minerals.

26. (canceled)

27. The stick gel type food composition according to claim 16, wherein the allulose is added as at least one selected from the group consisting of crystalline allulose, non-crystalline allulose and allulose syrup.

28-29. (canceled)

30. The stick gel type food composition according to claim 16, wherein the food composition further comprises at least one selected from the group consisting of sugar-alcohols, dextrin and oligosaccharides, and comprises 5 to 30% by weight of sugar-alcohols, 1 to 20% by weight of oligosaccharides, or 1 to 20% by weight of dextrin, based on the total weight of the food composition.

31. The stick gel type food composition according to claim 16, further comprising 1 to 30% by weight of sucrose.
